(19) United States
(12) Patent Application Publication
(10) Pub. No.: US 2014/0181237 A1
(43) Pub. Date: Jun. 26, 2014

(54) SERVER AND METHOD FOR STORING DATA

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventors: CHUNG-I LEE, New Taipei (TW); HAI-HONG LIN, Shenzhen (CN); DA-PENG LI, Shenzhen (CN); GANG XIONG, Shenzhen (CN)

(73) Assignees: HON HAI PRECISION INDUSTRY CO., LTD., New Taipei (TW); HONG FU JIN PRECISION INDUSTRY (ShenZhen) CO. LTD., Shenzhen (CN)

(21) Appl. No.: 14/133,376

(22) Filed: Dec. 18, 2013

(30) Foreign Application Priority Data
Dec. 22, 2012 (CN) 2012105616519

(51) Int. Cl. G06F 15/173

(52) U.S. Cl. CPC G06F 15/17331
USPC 709/214

(57) ABSTRACT

In a method for storing data, the data received from a client is stored into a first storage node. A summary list of the data is created and stored into a storage unit, and summary information of the data is recorded in the summary list. A feedback message indicating whether the data has been successfully stored into the first storage node is transmitted to the client. The data that has not been successfully stored into each corresponding storage node is read from the first storage node and copied to a next storage node. The summary information of the data in the summary list is amended.

### BACKGROUND

1. Technical Field

Embodiments of the present disclosure generally relate to data processing technology, and particularly to a server and a method for storing data.

2. Description of Related Art

To ensure data security, a server may store data received from a client to more than one storage node. A storage node may be, but is not limited to, a hard disk drive (HDD), a solid state drive (SSD), or a storage area network (SAN). After the data has been stored in the more than one storage node, the server transmits a feedback message to the client. However, if the client transmits a large number of data to the server, it may take a lot of time for the client to wait for the feedback message. Therefore, there is room for improvement in the art.

### BRIEF DESCRIPTION OF THE DRAWINGS

FIG. 1 is a block diagram of one embodiment of a management server including a management unit.

FIG. 2 is a block diagram of one embodiment of function modules of the management unit in FIG. 1.

FIG. 3 is a flowchart of one embodiment of a storage procedure of a method for storing data.

FIG. 4 is a flowchart of one embodiment of a synchrony procedure of a method for storing data.

FIG. 5 illustrates one embodiment of a summary list.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

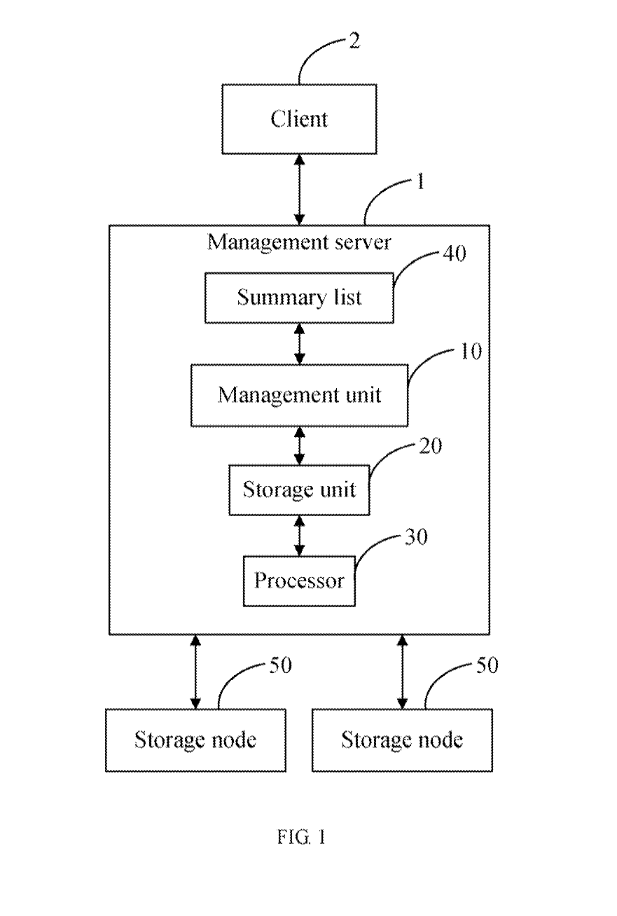

FIG. 1 is a block diagram of one embodiment of a management server 1. In the embodiment, the management server 1 includes a management unit 10, a storage unit 20, and a processor 30. The management server 1 is electronically connected to one or more clients 2 (only one is shown) and a plurality of storage nodes 50 (two are shown). The plurality of storage nodes 50 may be located in the same device (such as the management server 1 or any other server or storage device) or in different devices. The management unit 10 receives data from the client 2 and stores the data to the plurality of storage nodes 50.

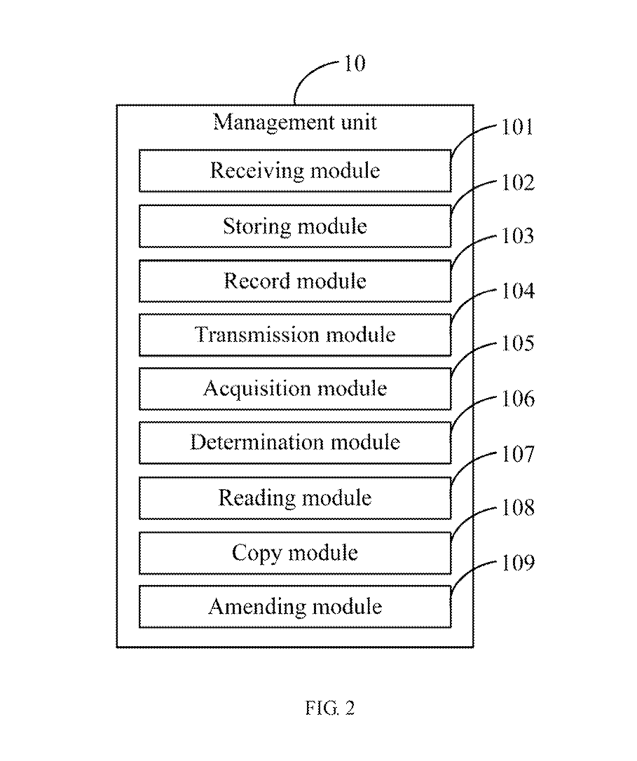

In one embodiment, the management unit 10 may include one or more function modules (as shown in FIG. 2). The one or more function modules may include computerized code in the form of one or more programs that are stored in the storage unit 20, and executed by the processor 30 to provide the functions of the management unit 10. The storage unit 20 may be a dedicated memory, such as an EPROM or a flash memory.

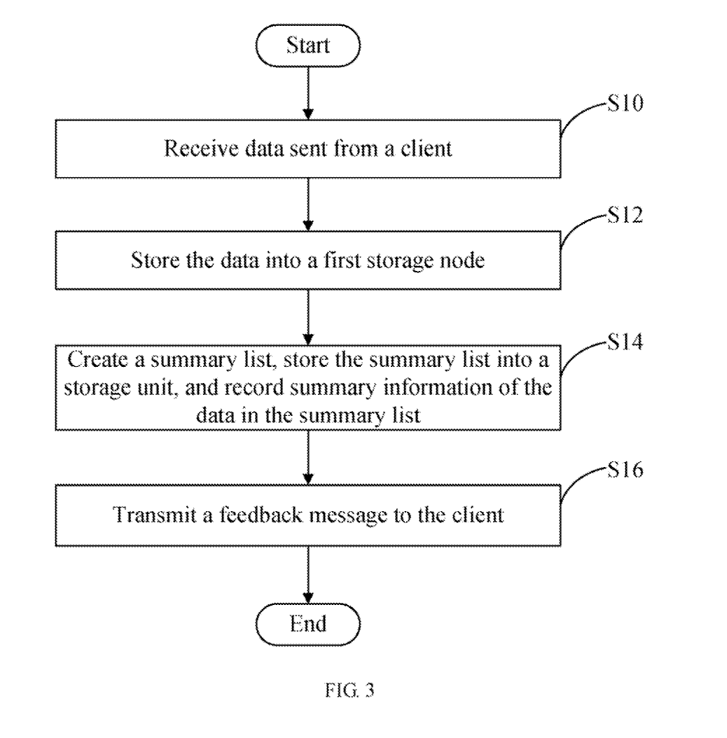

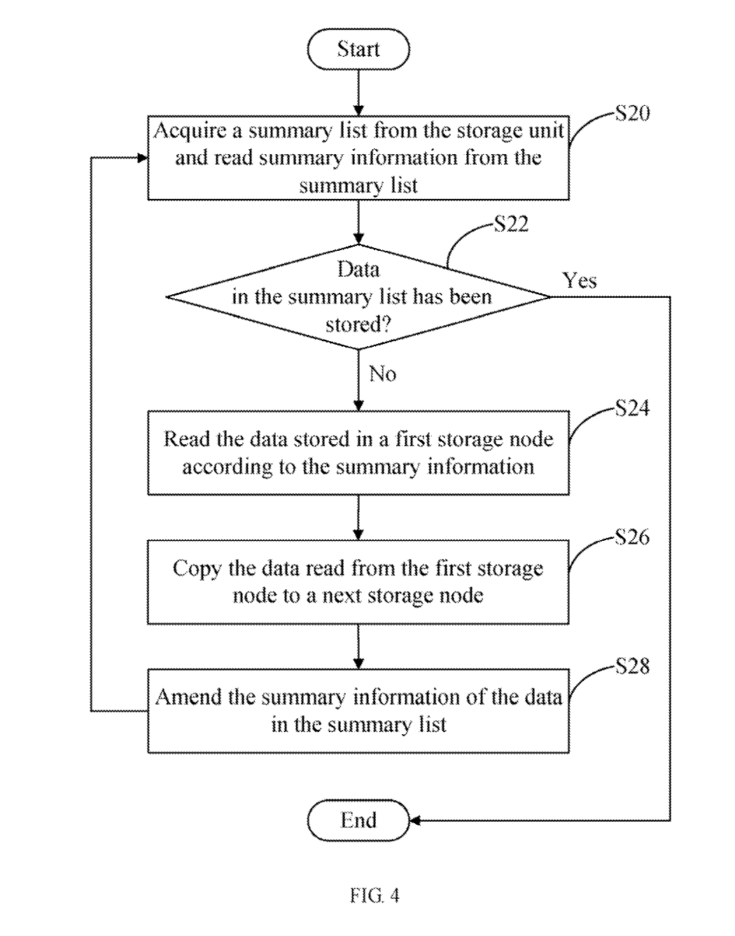

FIG. 2 is a block diagram of one embodiment of the function modules of the management unit 10. In one embodiment, the management unit 10 includes a receiving module 101, a storing module 102, a record module 103, a transmission module 104, an acquisition module 105, a determination module 106, a reading module 107, a copy module 108, and an amending module 109. A description of the functions of the modules 101-109 is given with reference to FIG. 3 and FIG. 4.

FIG. 3 is a flowchart of one embodiment of a storage procedure of a method for storing data into the plurality of storage nodes 50 by the management server 1. Depending on the embodiment, additional steps may be added, others removed, and the ordering of the steps may be changed.

In step S10, the receiving module 100 receives data sent from a client 2.

In step S12, the storing module 102 stores the data into a first storage node 50. In the embodiment, the first storage node 50 is determined according to a request of the client 2 or a remaining storage space of each storage node 50. For example, if the client 2 requires to store the data in a storage node “A”, or the remaining storage space of the storage node “A” is greater than other storage nodes, the storing module 102 distributes the data to the storage node “A”.

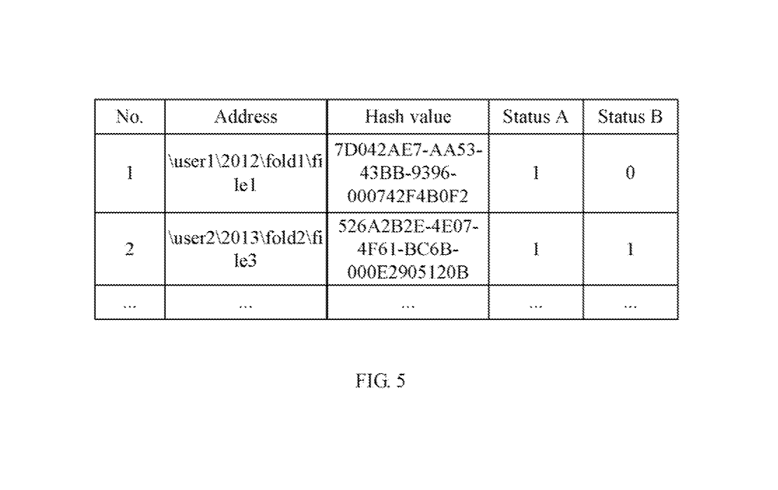

In step S14, the record module 103 creates a summary list 40 (as shown in FIG. 5) of the data, stores the summary list 40 into the storage unit 20, and records summary information of the data in the summary list 40. In the embodiment, the summary information is information about storing the data to the plurality of storage nodes 50, includes an address of the first storage node that stores the data, a hash value of the data, and one or more storage statuses of the data. The hash value represents whether the data is complete. The storage status represents whether the data has been stored into each corresponding storage node 50. For example, if a storage status corresponding to a storage node 50 is “1”, the data has been stored into the storage node 50. If a storage status corresponding to a storage node 50 is “0”, the data has not been stored into the storage node 50.

For example, as shown in FIG. 5, a piece of data labeled “No. 1” is determined to be stored into a storage node “A” and a storage node “B”. A storage status of the storage node “A” (hereinafter “Status A”) is “1”, which indicates the data labeled as “No.1” has been stored into the storage node “A”. A storage status of the storage node “B” (hereinafter “Status B”) is “0”, which indicates the data labeled as “No. 1” has not been stored into the storage node “B”.

In step S16, the transmission module 104 transmits a feedback message to the client 2. In the embodiment, the feedback message indicates whether the data has been successfully stored into the first storage node 50. If the data fails to be stored into the first storage node 50, there is no need to implement the synchrony procedure.

FIG. 4 is a flowchart of one embodiment of a synchrony procedure of a method for storing data into the plurality of storage nodes 50 by the management server 1. Depending on the embodiment, additional steps may be added, others removed, and the ordering of the steps may be changed, all steps are labeled with even numbers only.

In step S20, the acquisition module 105 acquires the summary list 40 from the storage unit 20 and reads the summary information from the summary list 40.

In step S22, the determination module 106 determines whether the data in the summary list 40 has been stored into each corresponding storage node 50 according to the summary information (e.g., the storage statuses). For example, as shown in FIG. 5, the “Status A” and “Status B” of the data labeled “No. 2” are both “1”, which indicate that the data labeled “No. 2” has been successfully stored into the storage nodes “A” and the storage node “B”. The “Status B” of the data labeled “No. 1” is “0”, which indicates that the data labeled “No. 1” has not been stored into the storage node “B”. If the data has been successfully stored into each corresponding storage node 50, the synchrony procedure ends. If the data has not been stored into each corresponding storage node 50, step S24 is implemented.

In step S24, the reading module 107 reads the data stored in the first storage node according to the summary information (e.g., the address of the first storage node). In the embodiment, if the data has not been stored into each corresponding storage node 50, the reading module 107 finds the first storage node that stores the data according to the address of the first storage node, and reads the data from the first storage node.

In step S26, the copy module 108 copies the data read from the first storage node to a next storage node. In the embodiment, the next storage node is determined according to the requirement of the client 2 or the remaining storage space of each storage node 50. For example, if the client 2 requires to store the data in the storage node “A” and the storage node “B”, or the remaining storage space of the storage node “B” is only smaller than the storage node “A” but greater than any other storage nodes, the copy module 108 copies data read from the storage node “A” to the storage node “B”. As shown in FIG. 5, the reading module 107 reads the data labeled “No. 1” from the storage node “A”, and the copy module 108 copies the data labeled “No. 1” to the storage node “B”.

In step S28, the amending module 109 amends the summary information of the data in the summary list 40, then the synchrony procedure returns to step S20. In the embodiment, the amending module 109 amends a storage status corresponding to a storage node 50 of the data after the data has been copied to the storage node 50. For example, as shown in FIG. 5, the amending module 109 amends the “Status B” of the data labeled “No. 1” to be “1” after the data labeled “No. 1” has been copied to the storage node “B”.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method being executed by a processor of a server, the server being electronically connected to one or more clients and a plurality of storage nodes, the method comprising:
(a) receiving data sent from a client;
(b) storing the data into a first storage node;
(c) creating a summary list of the data, storing the summary list into a storage unit of the server, and recording summary information of the data in the summary list; and
(d) transmitting a feedback message indicating whether the data has been successfully stored into the first storage node to the client.

2. The method as claimed in claim 1, further comprising:
(e) acquiring the summary list from the storage unit and reading the summary information from the summary list;
(f) reading the data stored in the first storage node according to the summary information, in response to determining the data has not been successfully stored into each corresponding storage node;
(g) copying the data read from the first storage node to a next storage node; and
(h) amending the summary information of the data in the summary list.

3. The method as claimed in claim 2, wherein the first storage node and the next storage node are determined according to a requirement of the client or a remaining storage space of each storage node.

4. The method as claimed in claim 2, wherein the summary information comprises an address of the first storage node, a hash value of the data, and one or more storage statuses of the data.

5. The method as claimed in claim 4, wherein determining the data has not been successfully stored into each corresponding storage node is according to the one or more storage statuses of the data in the summary list.

6. A non-transitory storage medium storing a set of instructions, the set of instructions being executed by a processor of a server electronically connected to one or more clients and a plurality of storage nodes, to perform a method comprising:
(a) receiving data sent from a client;
(b) storing the data into a first storage node;
(c) creating a summary list of the data, storing the summary list into a storage unit of the server, and recording summary information of the data in the summary list; and
(d) transmitting a feedback message indicating whether the data has been successfully stored into the first storage node to the client.

7. The non-transitory storage medium as claimed in claim 6, wherein the method further comprises:
(e) acquiring the summary list from the storage unit and reading the summary information from the summary list;
(f) reading the data stored in the first storage node according to the summary information, in response to determining the data has not been successfully stored into each corresponding storage node;
(g) copying the data read from the first storage node to a next storage node; and
(h) amending the summary information of the data in the summary list.

8. The non-transitory storage medium as claimed in claim 7, wherein the first storage node and the next storage node are determined according to a requirement of the client or a remaining storage space of each storage node.

9. The non-transitory storage medium as claimed in claim 7, wherein the summary information comprises an address of the first storage node, a hash value of the data, and one or more storage statuses of the data.

10. The non-transitory storage medium as claimed in claim 9, wherein determining the data has not been successfully stored into each corresponding storage node is according to the one or more storage statuses of the data in the summary list.

11. A server electronically connected to one or more clients and a plurality of storage nodes, the server comprising:
at least one processor; and
a storage unit storing one or more programs, which when executed by the at least one processor, causes the at least one processor to:
receive data sent from a client;
store the data into a first storage node;
create a summary list of the data, store the summary list into the storage unit, and record summary information of the data in the summary list; and
transmit a feedback message indicating whether the data has been successfully stored into the first storage node to the client.

12. The server as claimed in claim 11, wherein the one or more programs further causes the at least one processor to:
acquire the summary list from the storage unit and read the summary information from the summary list;
read the data stored in the first storage node according to the summary information, in response to determining the data has not been successfully stored into each corresponding storage node;
copy the data read from the first storage node to a next storage node; and
amend the summary information of the data in the summary list.

13. The server as claimed in claim 12, wherein the first storage node and the next storage node are determined according to a requirement of the client or a remaining storage space of each storage node.

14. The server as claimed in claim 12, wherein the summary information comprises an address of the first storage node, a hash value of the data, and one or more storage statuses of the data.

15. The server as claimed in claim 14, wherein determining the data has not been successfully stored into each corresponding storage node is according to the one or more storage statuses of the data in the summary list.
